(19) United States
(12) Patent Application Publication
(10) Pub. No.: US 2025/0391908 A1
(43) Pub. Date: Dec. 25, 2025

(54) POSITIVE ELECTRODE FOR SECONDARY BATTERY AND SECONDARY BATTERY

(71) Applicant: MURATA MANUFACTURING CO., LTD., Kyoto (JP)

(72) Inventor: Masaaki ITOU, Kyoto (JP)

(21) Appl. No.: 19/310,253

(22) Filed: Aug. 26, 2025

Related U.S. Application Data
(63) Continuation of application No. PCT/JP2024/012118, filed on Mar. 26, 2024.

(30) Foreign Application Priority Data
Mar. 28, 2023 (JP) 2023-051904

(51) Int. Cl. H01M 10/0525; H01M 4/02; H01M 4/62

(52) U.S. Cl. CPC H01M 10/0525; H01M 4/625; H01M 2004/021; H01M 2004/028

(57) ABSTRACT

A secondary battery includes a positive electrode including a positive electrode active material layer, a negative electrode, and an electrolytic solution. The positive electrode active material layer includes a positive electrode active material and a positive electrode conductor. The positive electrode conductor includes a carbon material. A half-width of a peak is 0.50 or less. The half-width of the peak is determinable by a procedure described in (1) to (3) below, based on a result of analysis of a surface of the positive electrode active material layer through Raman spectroscopy, (1) acquire Raman mapping of a D/G ratio by analyzing the surface of the positive electrode active material layer through the Raman spectroscopy, (2) acquire a histogram of the D/G ratio having the peak, based on the Raman mapping, and (3) calculate the half-width of the peak, based on the histogram.

### CROSS REFERENCE TO RELATED APPLICATIONS

The present application is a continuation of International Application No. PCT/JP2024/012118, filed Mar. 26, 2024, which claims priority to Japanese Patent No. 2023-051904, filed on Mar. 28, 2023, the entire contents of which are incorporated herein by reference.

### BACKGROUND

The present technology relates to a positive electrode for a secondary battery, and to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode (a positive electrode for a secondary battery), a negative electrode, and an electrolytic solution. A configuration of the secondary battery has been considered in various ways.

Specifically, a positive electrode material layer includes an electrically conductive material, and a Raman peak integrated intensity ratio for the positive electrode material layer is within a range of greater than 0.6 and less than or equal to 10. A positive electrode includes carbon black, nonfibrous graphite particles, and fibrous carbon. An electrode for a battery includes carbon nanotubes and a nonfibrous electrically conductive carbon material. A positive electrode mixture layer includes carbon black, first carbon nanotubes with a shorter fiber length, and second carbon nanotubes with a longer fiber length.

### SUMMARY

The present technology relates to a positive electrode for a secondary battery, and to a secondary battery.

Although consideration has been given in various ways regarding a configuration of a secondary battery, a battery characteristic of the secondary battery is not sufficient yet. Accordingly, there is room for improvement in terms of the battery characteristic of the secondary battery.

It is desirable to provide a positive electrode for a secondary battery, and a secondary battery each of which makes it possible to achieve an improved battery characteristic.

A positive electrode for a secondary battery according to an embodiment of the present technology includes a positive electrode active material layer. The positive electrode active material layer includes a positive electrode active material and a positive electrode conductor. The positive electrode conductor includes a carbon material. A half-width of a peak is 0.50 or less. The half-width of the peak is determinable by a procedure described in (1) to (3) below, based on a result of analysis of a surface of the positive electrode active material layer through Raman spectroscopy,
(1) Acquire Raman mapping of a D/G ratio by analyzing the surface of the positive electrode active material layer through the Raman spectroscopy.
(2) Acquire a histogram of the D/G ratio having the peak, based on the Raman mapping.
(3) Calculate the half-width of the peak, based on the histogram.

A secondary battery according to an embodiment of the present technology includes a positive electrode, a negative electrode, and an electrolytic solution. The positive electrode has a configuration similar to the configuration of the positive electrode for a secondary battery according to an embodiment of the present technology described above.

As used herein, the “D/G ratio” is an integrated intensity ratio of two peaks, i.e., a D-band peak and a G-band peak, to be detected by the analysis of the surface of the positive electrode active material layer through the Raman spectroscopy. The D/G ratio is an index indicating a crystalline state of the carbon material included as the positive electrode conductor in the positive electrode active material layer. The D/G ratio is calculable based on the following calculation expression: D/G ratio=integrated intensity (area) of D-band peak/integrated intensity (area) of G-band peak. Note that the D-band peak is a peak to be detected within a Raman shift range from about 1300 cm⁻¹ to about 1400 cm⁻¹. The G-band peak is a peak to be detected within a Raman shift range from about 1550 cm⁻¹ to about 1650 cm⁻¹.

In addition, the “half-width” is determinable based on the result of the analysis of the surface of the positive electrode active material layer through the Raman spectroscopy, as described above. The result includes the Raman mapping and the histogram. The half-width is what is called a full width at half maximum (FWHM). Note that a procedure for determining the half-width will be described in detail later.

According to the positive electrode for a secondary battery of an embodiment of the present technology or the secondary battery of an embodiment of the present technology, the positive electrode active material layer includes the positive electrode active material and the positive electrode conductor; the positive electrode conductor includes the carbon material; and the half-width of the peak determinable based on the result of the analysis of the surface of the positive electrode active material layer through the Raman spectroscopy is 0.50 or less. Accordingly, it is possible to achieve a superior battery characteristic.

Note that effects of the present technology are not necessarily limited to those described herein and may include any of a series of effects including described below and in relation to the present technology.

### BRIEF DESCRIPTION OF THE FIGURES

FIG. 1 is a sectional diagram illustrating a configuration of a positive electrode for a secondary battery according to an embodiment of the present technology.

FIG. 2 is a diagram illustrating an example of a histogram acquirable based on Raman mapping.

FIG. 3 is a perspective diagram illustrating a configuration of a secondary battery according to an embodiment of the present technology.

FIG. 4 is a sectional diagram illustrating a configuration of a battery device illustrated in FIG. 3.

FIG. 5 is a block diagram illustrating a configuration of an application example of the secondary battery.

FIG. 6 is a sectional diagram illustrating a configuration of a secondary battery for testing.

### DETAILED DESCRIPTION

The present disclosure is described below in further detail including with reference to the drawings according to an embodiment.

A description is given first of a positive electrode for a secondary battery according to an embodiment of the present technology. The positive electrode for a secondary battery is hereinafter simply referred to as the “positive electrode”.

The positive electrode to be described here is to be used in a secondary battery, which is an electrochemical device. However, the positive electrode may be used in electrochemical devices other than the secondary battery. Specific examples of the other electrochemical devices include a primary battery and a capacitor.

The positive electrode allows an electrode reactant to be inserted into and extracted from the positive electrode upon an operation of the electrochemical device (upon an electrode reaction). Although not particularly limited in kind, the electrode reactant is specifically a light metal such as an alkali metal or an alkaline earth metal. Specific examples of the alkali metal include lithium, sodium, and potassium. Specific examples of the alkaline earth metal include beryllium, magnesium, and calcium.

Examples are given below of a case where the electrode reactant is lithium. Accordingly, lithium may be inserted into and extracted from the positive electrode in an ionic state upon the electrode reaction.

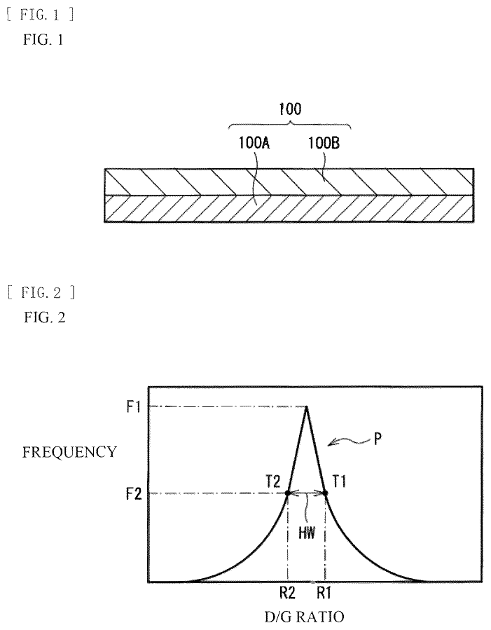

FIG. 1 illustrates a sectional configuration of a positive electrode 100 as a specific example of the positive electrode.

The positive electrode 100 includes a positive electrode active material layer 100B. Here, the positive electrode 100 further includes a positive electrode current collector 100A that supports the positive electrode active material layer 100B.

The positive electrode current collector 100A is an electrically conductive support that supports the positive electrode active material layer 100B, and has two opposed surfaces, i.e., an upper surface and a lower surface, on each of which the positive electrode active material layer 100B may be provided. The positive electrode current collector 100A includes an electrically conductive material such as a metal material. Specific examples of the electrically conductive material include aluminum.

The positive electrode active material layer 100B is a layer into which lithium is to be inserted and from which lithium is to be extracted, and is provided on one of the two opposed surfaces, i.e., on the upper surface or the lower surface, of the positive electrode current collector 100A. However, the positive electrode active material layer 100B may be provided on each of the two opposed surfaces, i.e., on each of the upper surface and the lower surface, of the positive electrode current collector 100A. The positive electrode active material layer 100B includes a positive electrode active material and a positive electrode conductor.

The positive electrode active material includes any one or more of materials into which lithium is to be inserted and from which lithium is to be extracted. The positive electrode active material is not particularly limited in kind, and is specifically, for example, a lithium-containing compound. One reason for this is that a high voltage is obtainable.

The lithium-containing compound is a compound that includes lithium and one or more transition metal elements as constituent elements. The lithium-containing compound may further include one or more other elements as one or more constituent elements. The one or more other elements are any one or more of elements other than lithium and the transition metal elements. The one or more other elements are not particularly limited in kind, and are specifically any one or more of elements belonging to groups 2 to 15 in the long period periodic table. The lithium-containing compound is not particularly limited in kind, and is specifically an oxide, a phosphoric acid compound, a silicic acid compound, or a boric acid compound, for example.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, and LiMn₂O₄. Specific examples of the phosphoric acid compound include LiFePO₄, LiMnPO₄, and LiFe_{0.5}Mn_{0.5}PO₄.

The positive electrode conductor is a material that improves electrical conductivity of the positive electrode active material layer 100B, and includes any one or more of carbon materials that are electrically conductive materials.

The carbon material is not particularly limited in kind, and specifically includes a particulate carbon material, a fibrous carbon material, or both. In other words, the positive electrode conductor may include only the particulate carbon material. The positive electrode conductor may include only the fibrous carbon material. The positive electrode conductor may include both the particulate carbon material and the fibrous carbon material. Note that only one particulate carbon material may be included, or two or more particulate carbon materials may be included. Likewise, only one fibrous carbon material may be included, or two or more fibrous carbon materials may be included.

Specific examples of the particulate carbon material include graphite, carbon black, acetylene black, and Ketjen black. Specific examples of the fibrous carbon material include carbon nanotubes, carbon fibers, and carbon nanofibers.

In particular, the carbon material preferably includes both the particulate carbon material and the fibrous carbon material. One reason for this is that this further improves the electrical conductivity of the positive electrode active material layer 100B.

To be more specific, when the carbon material includes both the particulate carbon material and the fibrous carbon material, the particulate carbon material is easily disposed on a surface of the positive electrode active material, and use of the particulate carbon material as a binding point allows the fibrous carbon material to be easily disposed across multiple positive electrode active materials. This makes it easy to form an electrically conductive network including the positive electrode active material, the particulate carbon material, and the fibrous carbon material in the positive electrode active material layer 100B. In contrast, when the carbon material includes either the particulate carbon material or the fibrous carbon material, it is not easy to form the electrically conductive network described above.

In the positive electrode 100, a physical property of the positive electrode active material layer 100B including the carbon material as the positive electrode conductor is made appropriate, which allows for improvement in dispersibility of the positive electrode conductor in the positive electrode active material layer 100B. The physical property of the positive electrode active material layer 100B described here will be described in detail later.

Note that the positive electrode conductor may further include any one or more of other electrically conductive materials including, without limitation, a metal material and an electrically conductive polymer compound.

The positive electrode active material layer 100B may further include a positive electrode binder. The positive electrode binder is a material that bonds the positive electrode active material and the positive electrode conductor to each other, and includes any one or more of materials including, without limitation, a synthetic rubber and a polymer compound. Specific examples of the synthetic rubber may include a styrene-butadiene-based rubber, a fluorine-based rubber, and ethylene propylene diene. Specific examples of the polymer compound may include polyvinylidene difluoride, polyimide, carboxymethyl cellulose.

FIG. 2 illustrates an example of a histogram acquirable based on Raman mapping. In the histogram, a horizontal axis represents a D/G ratio, and a vertical axis represents frequency.

In the positive electrode 100, the physical property of the positive electrode active material layer 100B including the carbon material as the positive electrode conductor is made appropriate, as described above. Specifically, a half-width HW of a peak P is 0.50 or less. The half-width HW is determinable by a procedure described in the following (1) to (3), based on a result of analysis of a surface of the positive electrode active material layer 100B through Raman spectroscopy. Note that a value of the half-width HW is a value rounded off to two decimal places.
(1) Acquire Raman mapping of a D/G ratio by analyzing the surface of the positive electrode active material layer 100B through the Raman spectroscopy.
(2) Acquire a histogram of the D/G ratio having the peak P, based on the Raman mapping acquired in (1) described above.
(3) Calculate the half-width HW of the peak P, based on the histogram acquired in (2) described above.

As used herein, the “D/G ratio” is an integrated intensity ratio of two peaks, i.e., a D-band peak and a G-band peak, detectable by the analysis of the surface of the positive electrode active material layer 100B through the Raman spectroscopy, as described above. The D/G ratio is an index indicating a crystalline state of the carbon material included as the positive electrode conductor in the positive electrode active material layer 100B. The D/G ratio is calculable based on the following calculation expression: D/G ratio=integrated intensity (area) of D-band peak/integrated intensity (area) of G-band peak.

Note that the D-band peak is a peak to be detected within a Raman shift range from about 1300 cm⁻¹ to about 1400 cm⁻¹. The G-band peak is a peak to be detected within a Raman shift range from about 1550 cm⁻¹ to about 1650 cm⁻¹.

In addition, the “half-width HW” is determinable based on the result of analysis of the surface of the positive electrode active material layer 100B through the Raman spectroscopy, as described above. The result includes the Raman mapping and the histogram. The half-width is what is called a full width at half maximum (FWHM).

A detailed procedure for determining the half-width HW is as described below. The procedure for determining the half-width HW is described through description of each of processes (1) to (3).

### (1) Acquisition of Raman Mapping

To determine the half-width HW, first, the surface of the positive electrode active material layer 100B is analyzed through the Raman spectroscopy to thereby acquire the Raman mapping of the D/G ratio. In this case, a laser Raman microscope RAMANforce available from Nanophoton Corporation may be used as a Raman spectrometer. Analysis conditions are an analysis range of 100 μm×100 μm, and an excitation wavelength of 532 nm.

The Raman mapping is a result of analyzing the surface of the positive electrode active material layer 100B through the Raman spectroscopy to thereby calculate the D/G ratio, and thereafter two-dimensionally displaying (mapping) the D/G ratio. In other words, the Raman mapping is a result of visualizing a distribution of the crystalline state of the carbon material determined based on the D/G ratio.

### (2) Acquisition of Histogram

Thereafter, as illustrated in FIG. 2, the histogram of the D/G ratio is acquired based on the Raman mapping acquired in (1). In this case, a function, i.e., a calculation process, of the Raman spectrometer is used to convert the Raman mapping into a histogram.

The histogram is a result of graphing the Raman mapping to thereby continuously represent a change in frequency of the D/G ratio. In the histogram, the frequency of the D/G ratio increases and then decreases. Thus, the peak P is detected.

### (3) Calculation of Half-Width HW

Lastly, the half-width HW of the peak P is calculated based on the histogram acquired in (2). As is apparent from FIG. 2, the half-width HW is a width of the peak P at a position where, with respect to a maximum frequency F1 of the peak P, the frequency is half the maximum frequency F1 (F2=F1/2). More specifically, the half-width HW is a value (HW=R1−R2) determined by subtracting a value (R2) of the D/G ratio corresponding to a point T2 from a value (R1) of the D/G ratio corresponding to a point T1.

To calculate the half-width HW, the surface of the positive electrode active material layer 100B is analyzed at ten locations different from each other through the Raman spectroscopy to thereby calculate ten half-widths based on results of the analysis at the ten locations (ten pieces of Raman mapping and ten histograms), following which an average value of the ten half-widths is determined to be the half-width HW.

Here, one reason why the half-width HW is 0.5 or less is that this improves the dispersibility of the positive electrode conductor in the positive electrode active material layer 100B, and thus allows for uniform distribution of the D/G ratio in the positive electrode active material layer 100B. In this case, in the positive electrode active material layer 100B, electrical resistance is made uniform, and physical strength is also made uniform. This facilitates uniform insertion and extraction of lithium in the positive electrode active material layer 100B upon charging and discharging of the secondary battery including the positive electrode 100, and facilitates uniform expansion and contraction of the positive electrode active material layer 100B. Accordingly, even upon repeated charging and discharging of the secondary battery, the positive electrode active material layer 100B is prevented from being degraded and damaged easily.

One reason why the half-width HW becomes 0.5 or less is that, as will be described later, when preparing a positive electrode mixture slurry in a process of manufacturing the positive electrode 100, the positive electrode conductor is added to a solvent including the positive electrode active material while stirring the solvent, with a time difference from addition of the positive electrode active material. That is, instead of adding the positive electrode active material and the positive electrode conductor together to the solvent, the positive electrode active material is added to the solvent, following which the positive electrode conductor is separately added to the solvent. In this case, the half-width HW is controllable to have a desired value by adjusting stirring conditions including, without limitation, a stirring speed and a stirring time.

The description given here in relation to the positive electrode conductor also applies to the positive electrode binder. Specifically, when the positive electrode active material layer 100B includes the positive electrode binder, in order to set the half-width HW to 0.5 or less, the positive electrode conductor and the positive electrode binder are added at different times to the solvent including the positive electrode active material while stirring the solvent in the process of manufacturing the positive electrode 100, i.e., upon preparation of the positive electrode mixture slurry. In other words, instead of adding the positive electrode active material, the positive electrode conductor, and the positive electrode binder together to the solvent, only one of the positive electrode conductor and the positive electrode binder is added to the solvent including the positive electrode active material, following which another one of the positive electrode conductor and the positive electrode binder is separately added to the solvent.

Note that a method of manufacturing the positive electrode 100 (including a procedure for preparing the positive electrode mixture slurry) will be described in detail later.

In the positive electrode 100, upon an electrode reaction, lithium is extracted, in an ionic state, from the positive electrode active material layer 100B, and lithium is inserted, in an ionic state, into the positive electrode active material layer 100B.

To manufacture the positive electrode 100, the positive electrode mixture slurry is prepared, following which the positive electrode 100 is fabricated using the positive electrode mixture slurry, in accordance with an example procedure to be described below.

A description is given below of a case where the positive electrode active material layer 100B is to be formed using the positive electrode mixture slurry that includes the positive electrode binder together with the positive electrode active material and the positive electrode conductor.

To prepare the positive electrode mixture slurry, as described below, a first dispersion liquid and a second dispersion liquid are prepared in this order, following which the positive electrode mixture slurry is prepared using the second dispersion liquid.

First, the positive electrode active material is put into a solvent, following which the solvent is stirred. This allows the positive electrode active material to be dispersed in the solvent. As a result, the first dispersion liquid is prepared.

The solvent is not particularly limited in kind, and may be an aqueous solvent, or may be a non-aqueous solvent (an organic solvent). In this case, a stirring apparatus such as a planetary centrifugal mixer, a homogenizer, or a ball mill may be used to stir the solvent. Stirring conditions including, without limitation, a stirring speed, i.e., a rotation speed of a stirring bar (rpm), and a stirring time (min) may be set as desired.

Thereafter, while stirring the first dispersion liquid, one of the positive electrode conductor and the positive electrode binder is added to the first dispersion liquid, following which the first dispersion liquid is stirred. In this case, the stirring apparatus described above may be used.

Accordingly, when the positive electrode conductor is added to the first dispersion liquid, the positive electrode conductor is dispersed in the first dispersion liquid, and as a result, the second dispersion liquid is prepared. In contrast, when the positive electrode binder is added to the first dispersion liquid, the positive electrode binder is dissolved in the first dispersion liquid, and as a result, the second dispersion liquid is prepared.

Lastly, while stirring the second dispersion liquid, another one of the positive electrode conductor and the positive electrode binder is added to the second dispersion liquid, following which the second dispersion liquid is stirred. “Another one” refers to the positive electrode binder when the positive electrode conductor is added to the first dispersion liquid, and refers to the positive electrode conductor when the positive electrode binder is added to the first dispersion liquid. In this case, the stirring apparatus described above may be used.

Thus, when the positive electrode conductor is added to the second dispersion liquid, the positive electrode conductor is dispersed in the second dispersion liquid, and as a result, the positive electrode mixture slurry is prepared. In contrast, when the positive electrode binder is added to the second dispersion liquid, the positive electrode binder is dissolved in the second dispersion liquid, and as a result, the positive electrode mixture slurry is prepared.

One reason why the positive electrode conductor and the positive electrode binder are added at different times to the solvent to prepare the positive electrode mixture slurry is that this improves the dispersibility of the positive electrode conductor in the positive electrode mixture, and thus allows the half-width HW to fall within the range described above.

To be more specific, when the positive electrode conductor is added alone to the first dispersion liquid separately from the positive electrode binder, the dispersibility of the positive electrode conductor in the first dispersion liquid improves, as compared with when both the positive electrode conductor and the positive electrode binder are added together to the first dispersion liquid. This makes it easy to uniformly disperse the positive electrode conductor in the first dispersion liquid.

Advantages related to the positive electrode conductor described here are obtainable similarly for the positive electrode binder. Specifically, when the positive electrode binder is added alone to the first dispersion liquid separately from the positive electrode conductor, dispersibility of the positive electrode binder in the first dispersion liquid improves, as compared with when both the positive electrode binder and the positive electrode conductor are added together to the first dispersion liquid. This makes it easy to uniformly dissolve the positive electrode binder in the first dispersion liquid.

Thus, the dispersibility of the positive electrode conductor improves in the positive electrode active material layer 100B that is to be formed using the positive electrode mixture slurry in a later process. This makes it easy to uniformly distribute the D/G ratio, which allows the half-width HW to fall within the range described above.

Advantages upon preparation of the first dispersion liquid described here are obtainable similarly for preparation of the second dispersion liquid. Specifically, when the positive electrode conductor is added alone to the second dispersion liquid separately from the positive electrode binder, the dispersibility of the positive electrode conductor in the second dispersion liquid improves. This makes it easy to uniformly disperse the positive electrode conductor in the second dispersion liquid. In addition, when the positive electrode binder is added alone to the second dispersion liquid separately from the positive electrode conductor, solubility of the positive electrode binder in the second dispersion liquid improves. This makes it easy to uniformly dissolve the positive electrode binder in the second dispersion liquid.

Note that when the positive electrode conductor is to be added to the first dispersion liquid, instead of adding the positive electrode conductor as it is to the first dispersion liquid, a dispersion liquid in which the positive electrode conductor is dispersed in a solvent in advance may be added to the first dispersion liquid. One reason for this is that this improves the dispersibility of the positive electrode conductor in the first dispersion liquid. Details of the solvent are as described above.

Needless to say, when the positive electrode conductor is to be added to the second dispersion liquid also, a dispersion liquid in which the positive electrode conductor is dispersed in the solvent in advance may be added to the second dispersion liquid similarly.

In addition, when the positive electrode binder is to be added to the first dispersion liquid, instead of adding the positive electrode binder as it is to the first dispersion liquid, a solution in which the positive electrode binder is dissolved in a solvent in advance may be added to the first dispersion liquid. One reason for this is that this improves the dispersibility of the positive electrode binder in the first dispersion liquid. Details of the solvent is as described above.

Needless to say, when the positive electrode binder is to be added to the second dispersion liquid also, a dispersion liquid in which the positive electrode conductor is dispersed in the solvent in advance may be added to the second dispersion liquid.

In addition, when two or more kinds of positive electrode conductors are to be used to prepare the positive electrode mixture slurry, the two or more kinds of positive electrode conductors are preferably added at different times to the solvent. One reason for this is that the dispersibility of each of the two or more kinds of positive electrode conductors in the positive electrode mixture slurry improves because of the reason described above.

For example, when two kinds of positive electrode conductors are to be used, the order of adding the positive electrode binder and the two kinds of positive electrode conductors may be any one of the following orders.

Firstly, (1) the positive electrode binder may be added; (2) a positive electrode conductor of a first kind may be added; and (3) a positive electrode conductor of a second kind may be added.

Secondly, (1) the positive electrode binder may be added; (2) the positive electrode conductor of the second kind may be added; and (3) the positive electrode conductor of the first kind may be added.

Thirdly, (1) the positive electrode conductor of the first kind may be added; (2) the positive electrode binder may be added; and (3) the positive electrode conductor of the second kind may be added.

Fourthly, (1) the positive electrode conductor of the first kind may be added; (2) the positive electrode conductor of the second kind may be added; and (3) the positive electrode binder may be added.

Fifthly, (1) the positive electrode conductor of the second kind may be added; (2) the positive electrode binder may be added; and (3) the positive electrode conductor of the first kind may be added.

Sixthly, (1) the positive electrode conductor of the second kind may be added; (2) the positive electrode conductor of the first kind may be added; and (3) the positive electrode binder may be added.

When the positive electrode 100 is to be fabricated using the positive electrode mixture slurry, the positive electrode mixture slurry is applied on one of the two opposed surfaces of the positive electrode current collector 100A to thereby form the positive electrode active material layer 100B. Thereafter, the positive electrode active material layer 100B may be compression-molded by a molding machine such as a roll pressing machine. In this case, the positive electrode active material layer 100B may be heated. The positive electrode active material layer 100B may be compression-molded multiple times.

The positive electrode active material layer 100B is thus formed on the one of the two opposed surfaces of the positive electrode current collector 100A. As a result, the positive electrode 100 is completed.

According to the positive electrode 100, the positive electrode active material layer 100B includes the positive electrode active material and the positive electrode conductor; the positive electrode conductor includes the carbon material; and the half-width HW of the peak P determinable based on the result of analysis of the surface of the positive electrode active material layer 100B through the Raman spectroscopy is 0.5 or less.

In this case, as described above, the dispersibility of the positive electrode conductor in the positive electrode active material layer 100B improves. This makes it easy to uniformly distribute the D/G ratio. Thus, in the positive electrode active material layer 100B, electrical resistance is made uniform, and the physical strength is also made uniform. This facilitates uniform insertion and extraction of lithium in the positive electrode active material layer 100B upon charging and discharging of the secondary battery including the positive electrode 100, and facilitates uniform expansion and contraction of the positive electrode active material layer 100B.

Based upon the foregoing, even upon repeated charging and discharging of the secondary battery, the positive electrode active material layer 100B is prevented from being degraded and damaged easily. It is therefore possible to achieve a secondary battery having a superior battery characteristic by including the positive electrode 100.

In particular, the carbon material may include the particulate carbon material and the fibrous carbon material. This makes it easy to form the electrically conductive network including the positive electrode active material, the particulate carbon material, and the fibrous carbon material in the positive electrode active material layer 100B. The electrical conductivity of the positive electrode active material layer 100B thus further improves. Accordingly, it is possible to achieve higher effects.

In addition, the positive electrode active material layer 100B may further include the positive electrode binder. This allows a bonding property between the positive electrode active material and the positive electrode conductor to improve while the half-wide HW is controlled to be within the range described above. Accordingly, it is possible to achieve higher effects.

A description is given next of a secondary battery according to an embodiment of the present technology to which the positive electrode 100 is to be applied.

The secondary battery to be described here is a secondary battery in which a battery capacity is obtained through insertion and extraction of an electrode reactant, and includes a positive electrode, a negative electrode, and an electrolytic solution. Examples are given below of a case where the electrode reactant is lithium as in the description given above. A secondary battery in which the battery capacity is obtained through insertion and extraction of lithium is what is called a lithium-ion secondary battery. In the lithium-ion secondary battery, lithium is inserted and extracted in an ionic state.

A charge capacity of the negative electrode is preferably greater than a discharge capacity of the positive electrode. In other words, an electrochemical capacity per unit area of the negative electrode is preferably greater than an electrochemical capacity per unit area of the positive electrode. This is to suppress precipitation of the electrode reactant on a surface of the negative electrode during charging.

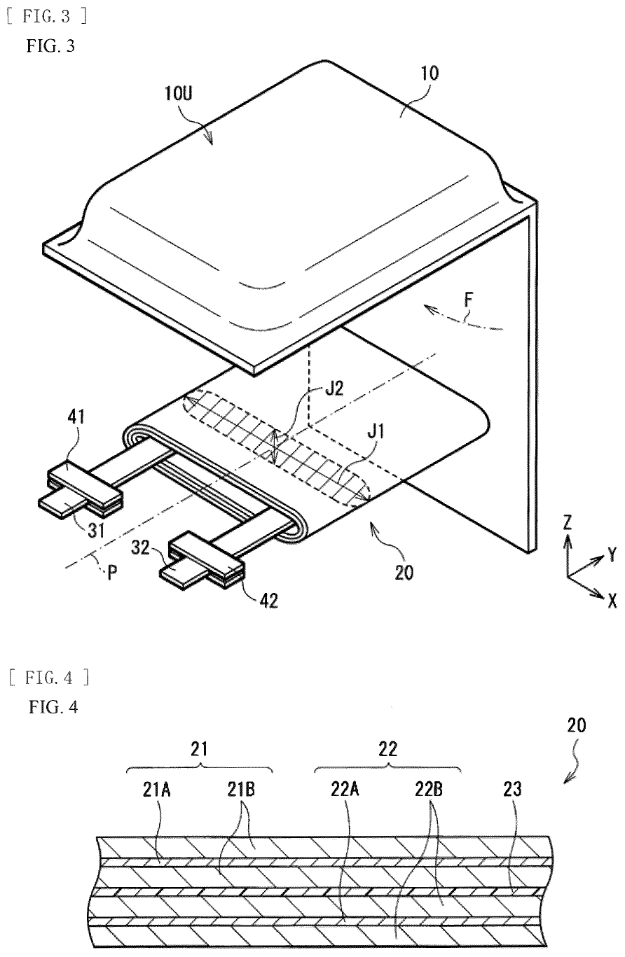

FIG. 3 illustrates a perspective configuration of the secondary battery. FIG. 4 illustrates, in an enlarged manner, a sectional configuration of a battery device 20 illustrated in FIG. 3. Note that FIG. 3 illustrates a state where an outer package film 10 and the battery device 20 are separated from each other, and illustrates a section of the battery device 20 along an XZ plane by a broken line. Further, FIG. 4 illustrates only a portion of the battery device 20.

The secondary battery includes the outer package film 10, the battery device 20, a positive electrode lead 31, a negative electrode lead 32, and sealing films 41 and 42. The secondary battery described here is a secondary battery of a laminated-film type including the outer package film 10 as an outer package member to contain the battery device 20. The outer package film 10 is flexible or soft.

The outer package film 10 has a pouch-shaped structure that is sealed in a state where the battery device 20 is contained in the outer package film 10. The outer package film 10 thus contains a positive electrode 21, a negative electrode 22, and an electrolytic solution that are to be described later.

Here, the outer package film 10 is a single film-shaped member and is folded toward a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state where the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 as the laminated film is not particularly limited in configuration or the number of layers, and may be single-layered or two-layered, or may include four or more layers.

The battery device 20 is a power generation device that includes the positive electrode 21, the negative electrode 22, a separator 23, and the electrolytic solution (not illustrated). The battery device 20 is contained in the outer package film 10.

The battery device 20 is what is called a wound electrode body. Accordingly, the positive electrode 21 and the negative electrode 22 are wound about a winding axis P, being opposed to each other with the separator 23 interposed therebetween. The winding axis P is a virtual axis extending in a Y-axis direction.

The battery device 20 is not particularly limited in three-dimensional shape. Here, the battery device 20 has an elongated shape. Accordingly, a section of the battery device 20 intersecting the winding axis P, that is, the section of the battery device 20 along the XZ plane, has an elongated shape defined by a major axis J1 and a minor axis J2. The major axis J1 is a virtual axis that extends in an X-axis direction and has a length larger than a length of the minor axis J2. The minor axis J2 is a virtual axis that extends in a Z-axis direction intersecting the X-axis direction and has the length smaller than the length of the major axis J1. Here, the battery device 20 has an elongated cylindrical three-dimensional shape. Thus, the section of the battery device 20 has an elongated, substantially elliptical shape.

The positive electrode 21 has a configuration similar to that of the positive electrode 100.

Specifically, the positive electrode 21 includes a positive electrode current collector 21A and a positive electrode active material layer 21B. The positive electrode current collector 21A has a configuration similar to that of the positive electrode current collector 100A. The positive electrode active material layer 21B has a configuration similar to that of the positive electrode active material layer 100B. Here, the positive electrode active material layer 21B is provided on each of two opposed surfaces of the positive electrode current collector 21A.

The negative electrode 22 includes a negative electrode current collector 22A and a negative electrode active material layer 22B.

The negative electrode current collector 22A has two opposed surfaces on each of which the negative electrode active material layer 22B is to be provided. The negative electrode current collector 22A includes an electrically conductive material such as a metal material. Specific examples of the electrically conductive material include copper.

The negative electrode active material layer 22B includes any one or more of negative electrode active materials into which lithium is to be inserted and from which lithium is to be extracted. Note that the negative electrode active material layer 22B may further include any one or more of other materials including, without limitation, a negative electrode binder and a negative electrode conductor. A method of forming the negative electrode active material layer 22B is not particularly limited, and specifically includes any one or more of methods including, without limitation, a coating method, a vapor-phase method, a liquid-phase method, a thermal spraying method, and a firing (sintering) method.

Here, the negative electrode active material layer 22B is provided on each of the two opposed surfaces of the negative electrode current collector 22A. Note that the negative electrode active material layer 22B may be provided only on one of the two opposed surfaces of the negative electrode current collector 22A on a side where the negative electrode 22 is opposed to the positive electrode 21.

The negative electrode active material is not particularly limited in kind, and specific examples thereof include a carbon material and a metal-based material. One reason for this is that this allows for a high energy density.

Specific examples of the carbon material include graphitizable carbon, non-graphitizable carbon, and graphite (natural graphite and artificial graphite).

The metal-based material is a material that includes, as one or more constituent elements, any one or more elements among metal elements and metalloid elements that are each able to form an alloy with lithium. Specific examples of the metal elements and the metalloid elements include silicon and tin. The metal-based material may be a simple substance, an alloy, a compound, a mixture of two or more thereof, or a material including two or more phases thereof. The simple substance may include any amount of impurity. Accordingly, purity of the simple substance does not necessarily have to be 100%. Specific examples of the metal-based material include TiSi₂ and SiOₓ (where 0<x≤2 or 0.2<x<1.4).

The negative electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The negative electrode conductor includes any one or more of electrically conductive materials including, without limitation, a carbon material, a metal material, and an electrically conductive polymer compound. Specific examples of the carbon material include graphite, carbon black, acetylene black, and Ketjen black.

The separator 23 is an insulating porous film interposed between the positive electrode 21 and the negative electrode 22, and allows a lithium ion to pass therethrough while preventing a short circuit caused by contact between the positive electrode 21 and the negative electrode 22. The separator 23 includes a polymer compound such as polyethylene.

The electrolytic solution is a liquid electrolyte. The positive electrode 21, the negative electrode 22, and the separator 23 are each impregnated with the electrolytic solution. The electrolytic solution includes a solvent and an electrolyte salt.

Here, the solvent includes any one or more of non-aqueous solvents (organic solvents). The electrolytic solution including the one or more non-aqueous solvents is what is called a non-aqueous electrolytic solution. The non-aqueous solvent includes, for example, an ester or an ether, more specifically, any one or more of a carbonic-acid-ester-based compound, a carboxylic-acid-ester-based compound, or a lactone-based compound. One reason for this is that this improves a dissociation property of the electrolyte salt and ion mobility.

The carbonic-acid-ester-based compound is a cyclic carbonic acid ester or a chain carbonic acid ester. Specific examples of the cyclic carbonic acid ester include ethylene carbonate and propylene carbonate. Specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include ethyl acetate, ethyl propionate, propyl propionate, and ethyl trimethylacetate. The lactone-based compound is, for example, a lactone. Specific examples of the lactone include y-butyrolactone and γ-valerolactone. Note that the ether may be, for example, 1,2-dimethoxy ethane, tetrahydrofuran, 1,3-dioxolane, or 1,4-dioxane.

The electrolyte salt includes any one or more of light metal salts including, without limitation, a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris (trifluoromethanesulfonyl) methide (LiC(CF₃SO₂)₃), lithium bis(oxalato) borate (LiB(C₂O₄)₂), lithium monofluorophosphate (Li₂PFO₃), and lithium difluorophosphate (LiPF₂O₂). One reason for this is that a high battery capacity is obtainable.

A content of the electrolyte salt is not particularly limited, and is specifically within a range from 0.3 mol/kg to 3.0 mol/kg both inclusive with respect to the solvent. One reason for this is that this allows for high ion conductivity.

Note that the electrolytic solution may further include any one or more of additives. One reason for this is that this improves electrochemical stability of the electrolytic solution. The additives are not particularly limited in kind, and specific examples thereof include an unsaturated cyclic carbonic acid ester, a fluorinated cyclic carbonic acid ester, a sulfonic acid ester, a phosphoric acid ester, an acid anhydride, a nitrile compound, and an isocyanate compound.

Specific examples of the unsaturated cyclic carbonic acid ester include vinylene carbonate, vinyl ethylene carbonate, and methylene ethylene carbonate. Specific examples of the fluorinated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

The positive electrode lead 31 is a positive electrode terminal coupled to the positive electrode current collector 21A, and is led to an outside of the outer package film 10. The positive electrode lead 31 includes an electrically conductive material such as a metal material. Specific examples of the electrically conductive material include aluminum. The positive electrode lead 31 is not particularly limited in shape, and specifically has any one of shapes including, without limitation, a thin plate shape and a meshed shape.

The negative electrode lead 32 is a negative electrode terminal coupled to the negative electrode current collector 22A, and is led to the outside of the outer package film 10. The negative electrode lead 32 includes an electrically conductive material such as a metal material. Specific examples of the electrically conductive material include copper. Here, details of a direction in which the negative electrode lead 32 is led, and a shape of the negative electrode lead 32 are similar to those of the direction in which the positive electrode lead 31 is led, and the shape of the positive electrode lead 31.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry of, for example, outside air into the outer package film 10. Specifically, the sealing film 41 includes a polymer compound such as a polyolefin that has adherence to the positive electrode lead 31. Specific examples of the polyolefin include polypropylene.

A configuration of the sealing film 42 is similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

The secondary battery operates as described below upon charging and discharging.

Upon charging, in the battery device 20, lithium is extracted from the positive electrode 21, and the extracted lithium is inserted into the negative electrode 22 via the electrolytic solution. Upon discharging, in the battery device 20, lithium is extracted from the negative electrode 22, and the extracted lithium is inserted into the positive electrode 21 via the electrolytic solution. Upon each of the charging and the discharging, lithium is inserted and extracted in an ionic state.

To manufacture the secondary battery, the positive electrode 21 and the negative electrode 22 are each fabricated and the electrolytic solution is prepared, following which the secondary battery is assembled using the positive electrode 21, the negative electrode 22, and the electrolytic solution, and the assembled secondary battery is subjected to a stabilization process, in accordance with an example procedure described below.

The positive electrode 21 is fabricated by forming the positive electrode active material layers 21B on the two respective opposed surfaces of the positive electrode current collector 21A by a procedure similar to the fabrication procedure of the positive electrode 100 described above.

First, a mixture (a negative electrode mixture) in which the negative electrode active material, the negative electrode binder, and the negative electrode conductor are mixed with each other is put into a solvent to thereby prepare a negative electrode mixture slurry in paste form. The solvent may be an aqueous solvent, or may be a non-aqueous solvent (an organic solvent). Thereafter, the negative electrode mixture slurry is applied on the two opposed surfaces of the negative electrode current collector 22A to thereby form the negative electrode active material layers 22B. Thereafter, the negative electrode active material layers 22B may be compression-molded. The negative electrode active material layers 22B are thus formed on the two respective opposed surfaces of the negative electrode current collector 22A. As a result, the negative electrode 22 is fabricated.

The electrolyte salt is put into the solvent. The electrolyte salt is thereby dispersed or dissolved in the solvent. As a result, the electrolytic solution is prepared.

First, the positive electrode lead 31 is coupled to the positive electrode current collector 21A by a joining method such as a welding method, and the negative electrode lead 32 is coupled to the negative electrode current collector 22A by the joining method such as the welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body (not illustrated). Thereafter, the wound body is pressed by, for example, a pressing machine to thereby shape the wound body into an elongated shape. The shaped wound body has a configuration similar to that of the battery device 20 except that the positive electrode 21, the negative electrode 22, and the separator 23 are each not impregnated with the electrolytic solution.

Thereafter, the wound body is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained inside the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by the bonding method such as the thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution. Thus, the battery device 20 that is a wound electrode body is formed, and the battery device 20 is sealed in the outer package film 10 having the pouch shape. As a result, the secondary battery is assembled.

The assembled secondary battery is charged and discharged. Various conditions including, for example, an environment temperature, the number of times of charging and discharging (the number of cycles), and charging and discharging conditions, may be set as desired. As a result, a film is formed on the surface of each of the positive electrode 21 and the negative electrode 22, which electrochemically stabilizes a state of the battery device 20. The secondary battery is thus completed.

According to the secondary battery, the positive electrode 21 has a configuration similar to that of the positive electrode 100. Accordingly, even upon repeated charging and discharging, the positive electrode active material layer 21B is prevented from being degraded and damaged easily, for the reason described above. Thus, a reduction in discharge capacity is suppressed even upon repeated charging and discharging. It is therefore possible to achieve a superior battery characteristic.

In particular, the secondary battery may include a lithium-ion secondary battery. This makes it possible to obtain a sufficient battery capacity stably through insertion and extraction of lithium. Accordingly, it is possible to achieve higher effects.

Other action and effects of the secondary battery are similar to those of the positive electrode 100.

The configuration of the secondary battery described herein is appropriately modifiable including as described below according to an embodiment. Note that any two or more of the following series of modification examples may be combined with each other.

The separator 23 that is a porous film is used. However, although not specifically illustrated here, a separator of a stacked type including a polymer compound layer may be used.

Specifically, the separator of the stacked type includes a porous film having two opposed surfaces, and the polymer compound layer provided on one of or each of the two opposed surfaces of the porous film. One reason for this is that adherence of the separator to each of the positive electrode 21 and the negative electrode 22 improves to suppress misalignment of the battery device 20 (winding displacement of each of the positive electrode 21, the negative electrode 22, and the separator 23). This suppresses swelling of the secondary battery even if a decomposition reaction of the electrolytic solution occurs. The polymer compound layer includes a polymer compound such as polyvinylidene difluoride. One reason for this is that polyvinylidene difluoride is superior in physical strength and is electrochemically stable.

Note that the porous film, the polymer compound layer, or both may include multiple insulating particles. One reason for this is that the insulating particles promote heat dissipation upon heat generation by the secondary battery, thus improving safety or heat resistance of the secondary battery. The insulating particles include any one or more of insulating materials including, without limitation, inorganic materials and resin materials. Specific examples of the inorganic materials include aluminum oxide, aluminum nitride, boehmite, silicon oxide, titanium oxide, magnesium oxide, and zirconium oxide. Specific examples of the resin materials include acrylic resin and styrene resin.

To fabricate the separator of the stacked type, a precursor solution including, without limitation, the polymer compound and an organic solvent is prepared, following which the precursor solution is applied on one of or each of the two opposed surfaces of the porous film. In this case, the precursor solution may include the insulating particles.

When the separator of the stacked type is used also, lithium is movable between the positive electrode 21 and the negative electrode 22, and similar effects are therefore achievable. In this case, in particular, the secondary battery improves in safety, as described above. Accordingly, it is possible to achieve higher effects.

The electrolytic solution, which is a liquid electrolyte, is used. However, although not specifically illustrated here, an electrolyte layer, which is a gel electrolyte, may be used.

In the battery device 20 including the electrolyte layer, the positive electrode 21 and the negative electrode 22 are opposed to each other with the separator 23 and the electrolyte layer interposed therebetween, and are wound. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. One reason for this is that leakage of the electrolytic solution is prevented. The configuration of the electrolytic solution is as described above. The polymer compound includes, for example, polyvinylidene difluoride. To form the electrolyte layer, a precursor solution including, for example, the electrolytic solution, the polymer compound, and a solvent is prepared, following which the precursor solution is applied on one side or both sides of the positive electrode 21 and on one side or both sides of the negative electrode 22.

When the electrolyte layer is used also, lithium is movable between the positive electrode 21 and the negative electrode 22 via the electrolyte layer, and similar effects are therefore achievable. In this case, in particular, the leakage of the electrolytic solution is prevented, as described above. Accordingly, it is possible to achieve higher effects.

Applications (application examples) of the secondary battery are not particularly limited. The secondary battery used as a power source may serve as a main power source or an auxiliary power source in, for example, electronic equipment and an electric vehicle. The main power source is preferentially used regardless of the presence of any other power source. The auxiliary power source may be used in place of the main power source, and is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery packs may each include a battery cell, or may each include an assembled battery. The electric vehicle is a vehicle that travels with the secondary battery as a driving power source, and may be a hybrid automobile that is additionally provided with a driving source other than the secondary battery. In the electric power storage system for home use, electric power accumulated in the secondary battery that is an electric power storage source may be utilized for using, for example, home appliances.

An application example of the secondary battery will now be described in detail. The configuration of the application example described below is merely an example, and is appropriately modifiable.

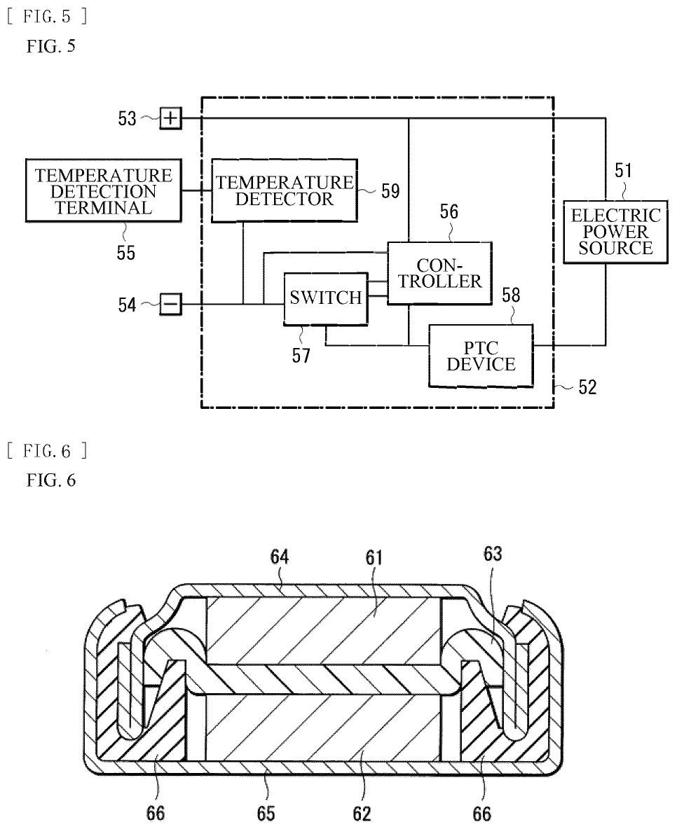

FIG. 5 illustrates a block configuration of a battery pack. The battery pack described here is a battery pack (what is called a soft pack) including one secondary battery, and is to be mounted on, for example, electronic equipment typified by a smartphone.

As illustrated in FIG. 5, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a PTC device 58, and a temperature detector 59. However, the PTC device 58 may be omitted.

The controller 56 includes, for example, a central processing unit (CPU) and a memory, and controls an overall operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited, and is specifically 4.20 V±0.05 V. The overdischarge detection voltage is not particularly limited, and is specifically 2.40 V±0.1 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging and discharging currents are detected based on an ON-resistance of the switch 57.

The temperature detector 59 includes a temperature detection device such as a thermistor. The temperature detector 59 measures a temperature of the electric power source 51 through the temperature detection terminal 55, and outputs a result of the temperature measurement to the controller 56. The result of the temperature measurement to be obtained by the temperature detector 59 is used, for example, when the controller 56 performs charge and discharge control upon abnormal heat generation or when the controller 56 performs a correction process upon calculating a remaining capacity.

### EXAMPLES

A description is given of Examples of the present technology according to an embodiment.

### Examples 1 to 4 and Comparative Examples 1 to 5

Secondary batteries were manufactured, following which the secondary batteries were each evaluated for a battery characteristic, as described below.

### [Manufacturing of Secondary Battery]

FIG. 6 illustrates a sectional configuration of a secondary battery for testing. The secondary battery for testing is a secondary battery (a lithium-ion secondary battery) of what is called a coin type.

The secondary battery included a test electrode 61, a counter electrode 62, a separator 63, an outer package cup 64, an outer package can 65, a gasket 66, and an electrolytic solution (not illustrated).

The test electrode 61 was placed in the outer package cup 64, and the counter electrode 62 was placed in the outer package can 65. The test electrode 61 and the counter electrode 62 were stacked on each other with the separator 63 interposed therebetween. The test electrode 61, the counter electrode 62, and the separator 63 were each impregnated with the electrolytic solution. The outer package cup 64 and the outer package can 65 were crimped to each other by the gasket 66. The test electrode 61, the counter electrode 62, and the separator 63 were each thus sealed in the outer package cup 64 and the outer package can 65.

The secondary battery illustrated in FIG. 6 was fabricated by the following procedure.

### [Fabrication of Test Electrode]

First, a powdered positive electrode active material (LiCoO₂ as a lithium-containing compound (an oxide)) was put into a solvent (N-methyl-2-pyrrolidone as an organic solvent), following which the solvent was stirred by a stirring apparatus (a homogenizer) having a stirring bar to thereby prepare a first dispersion liquid. Stirring conditions were a stirring speed, i.e., a rotation speed of a stirring bar, of 3000 rpm and a stirring time of 15 minutes.

Thereafter, two kinds of powdered positive electrode conductors (carbon materials) and a pellet-shaped positive electrode binder were added at different times to the first dispersion liquid while stirring the first dispersion liquid to thereby prepare a positive electrode mixture slurry.

For the two kinds of positive electrode conductors, carbon black (CB, having a median diameter of primary particles of 23 nm) was used as a positive electrode conductor of a first kind (a particulate carbon material), and carbon nanotubes (CNT, having an average fiber diameter of 15 μm and an average fiber length of 150 μm) were used as a positive electrode conductor of a second kind (a fibrous carbon material). Polyvinylidene difluoride (PVDF) was used as the positive electrode binder.

Here, in particular, a positive electrode conductor solution was used, and a positive electrode binder solution was used. In the positive electrode conductor solution, the positive electrode conductor of the second kind (carbon nanotubes) was dispersed in a solvent (N-methyl-2-pyrrolidone) in advance. In the positive electrode binder solution, the positive electrode binder (polyvinylidene difluoride) was dissolved in a solvent (N-methyl-2-pyrrolidone) in advance.

To prepare the positive electrode mixture slurry, as presented in Table 1, an operation of adding one of the positive electrode conductor of the first kind, the positive electrode conductor of the second kind, or the positive electrode binder and thereafter performing stirring with the stirring apparatus was repeated in three processes (a first process, a second process, and a third process). The two kinds of positive electrode conductors and the positive electrode binder were thus added at different times from each other.

A “Material” column in Table 1 indicates a kind of the material added in each of the processes. “PVDF” indicates the positive electrode binder (polyvinylidene difluoride). “CB” indicates the positive electrode conductor of the first kind (carbon black). “CNT” indicates the positive electrode conductor of the second kind (the carbon nanotubes). Stirring conditions, i.e., the stirring speed (rpm) and the stirring time (min) were as presented in Table 1.

For example, a procedure for preparing the positive electrode mixture slurry in Example 1 was as described below.

First, the first dispersion liquid including the positive electrode active material was prepared by the procedure described above. Thereafter, while stirring the first dispersion liquid, the positive electrode conductor of the first kind (carbon black) was added to the first dispersion liquid, following which the first dispersion liquid was stirred to thereby prepare a second dispersion liquid (the first process). Thereafter, while stirring the second dispersion liquid, the positive electrode binder (polyvinylidene difluoride) was added to the second dispersion liquid, following which the second dispersion liquid was stirred to thereby prepare a third dispersion liquid (the second process). Lastly, while stirring the third dispersion liquid, the positive electrode conductor of the second kind (the carbon nanotubes) was added to the third dispersion liquid, following which the third dispersion liquid was stirred to thereby prepare the positive electrode mixture slurry (the third process).

After the preparation of the positive electrode mixture slurry, the positive electrode 100 was fabricated using the positive electrode mixture slurry. Specifically, the positive electrode mixture slurry was applied on one of two opposed surfaces of the positive electrode current collector (an aluminum foil having a thickness of 12 μm) by a coating apparatus, following which the positive electrode mixture slurry was dried to thereby form the positive electrode active material layer.

Lastly, the positive electrode current collector with the positive electrode active material layer formed thereon was punched into a disk shape (having a diameter of 16.5 mm). The test electrode 61 was thus fabricated (Examples 1 to 3 and Comparative examples 1 to 4).

In fabricating the test electrode 61, the order of adding a series of materials (the two kinds of positive electrode conductors and the positive electrode binder), and stirring conditions, i.e., the stirring speed and the stirring time, in each of the processes were changed as presented in Table 1 in a process of adjusting the positive electrode mixture slurry. Thus, the half-width HW was changed. Note that a procedure for determining the half-width HW was as described above.

Here, a test electrode 61 for comparison was fabricated by a similar procedure except that, instead of separately adding the series of materials (the two kinds of positive electrode conductors and the positive electrode binder) at different times, the series of materials was added together in the process of adjusting the positive electrode mixture slurry (Comparative example 5).

### [Fabrication of Counter Electrode]

A lithium metal plate was punched into a disk shape (having a diameter of 17 mm). The counter electrode 62 was thus obtained.

### [Preparation of Electrolytic Solution]

An electrolyte salt (lithium hexafluorophosphate (LiPF₆)) was added to a solvent (ethylene carbonate as a cyclic carbonic acid ester and diethyl carbonate as a chain carbonic acid ester), following which the solvent was stirred. In this case, a mixture ratio (a weight ratio) between ethylene carbonate and diethyl carbonate in the solvent was set to 30:70. A content of the electrolyte salt in the electrolytic solution was set to 1 mol/kg with respect to the solvent. As a result, the electrolytic solution was prepared.

### [Assembly of Secondary Battery]

First, the test electrode 61 was placed in the outer package cup 64, and the counter electrode 62 was placed in the outer package can 65. Thereafter, the test electrode 61 placed in the outer package cup 64 and the counter electrode 62 placed in the outer package can 65 were stacked on each other with the separator 63 (a fine porous polyethylene film having a thickness of 20 μm) impregnated with the electrolytic solution being interposed between the test electrode 61 and the counter electrode 62. In this case, the test electrode 61 was so disposed that the positive electrode active material layer and the counter electrode 62 were opposed to each other with the separator 63 interposed therebetween. Thereafter, the outer package cup 64 and the outer package can 65 were crimped to each other by the gasket 66 in a state where the test electrode 61 and the counter electrode 62 were stacked on each other with the separator 63 interposed therebetween. The test electrode 61 and the counter electrode 62 were thereby sealed in the outer package cup 64 and the outer package can 65. The secondary battery was thus assembled.

### [Stabilization of Assembled Secondary Battery]

The secondary battery was charged and discharged for one cycle in an ambient temperature environment (at a temperature of 23° C.). Upon charging, the secondary battery was charged with a constant current of 0.1 C until a voltage reached 4.2 V, and was thereafter charged with a constant voltage of that value, 4.2 V, until a current reached 0.025 C. Upon discharging, the secondary battery was discharged with a constant current of 0.1 C until the voltage reached 3.0 V. Note that 0.1 C was a value of a current that caused a battery capacity (a theoretical capacity) to be completely discharged in 10 hours, and 0.025 C was a value of a current that caused the battery capacity to be completely discharged in 40 hours.

Thus, the test electrode 61 and the counter electrode 62 were each electrochemically stabilized. As a result, the secondary battery was completed.

### [Evaluation of Battery Characteristic]

The secondary batteries were each evaluated for a cyclability characteristic as the battery characteristic, and the evaluation revealed the results presented in Table 1.

To evaluate a cycle test, first, the secondary battery was charged and discharged in an ambient temperature environment (at a temperature of 23° C.) to thereby measure a discharge capacity (a first-cycle discharge capacity). Thereafter, the secondary battery was repeatedly charged and discharged in the same environment until the number of cycles reached 100 to thereby measure the discharge capacity (a 100th-cycle discharge capacity). Lastly, a capacity retention rate that was an index for evaluating the cyclability characteristic was calculated based on the following calculation expression: capacity retention rate (%)=(100th-cycle discharge capacity/first-cycle discharge capacity)×100. Charging and discharging conditions were similar to the charging and discharging conditions for the stabilization process of the assembled secondary battery.

Note that values of the capacity retention rate listed in Table 1 are normalized values that were obtained with respect to the value of the capacity retention rate of Example 1 assumed to be 100.

TABLE 1
Positive electrode active material: LiCoO₂

| | First process | | | Second process | | | Third process | | | | Capacity |
|---|---|---|---|---|---|---|---|---|---|---|---|
| | | Stirring | Stirring | | Stirring | Stirring | | Stirring | Stirring | Half- | retention |
| | | speed | time | | speed | time | | speed | time | width | rate |
| | Material | (rpm) | (min) | Material | (rpm) | (min) | Material | (rpm) | (min) | HW | (%) |
| Example 1 | CB | 3000 | 15 | PVDF | 2000 | 30 | CNT | 2000 | 15 | 0.50 | 100 |
| Example 2 | CB | 3000 | 15 | CNT | 2000 | 15 | PVDF | 2000 | 30 | 0.43 | 98 |
| Example 3 | PVDF | 3000 | 15 | CB | 2000 | 30 | CNT | 2000 | 15 | 0.45 | 99 |
| Example 4 | PVDF | 3000 | 15 | CNT | 2000 | 15 | CB | 2000 | 30 | 0.43 | 98 |
| Comparative example 1 | CB | 2000 | 15 | PVDF | 3000 | 15 | CNT | 2000 | 30 | 0.60 | 93 |
| Comparative example 2 | CB | 2000 | 15 | CNT | 3000 | 15 | PVDF | 2000 | 30 | 0.61 | 95 |
| Comparative example 3 | PVDF | 2000 | 15 | CB | 2000 | 30 | CNT | 3000 | 15 | 0.58 | 94 |
| Comparative example 4 | PVDF | 3000 | 15 | CNT | 2000 | 30 | CB | 2000 | 15 | 0.61 | 93 |
| Comparative example 5 | CB + CNT + PVDF | 3000 | 60 | — | — | — | — | — | — | 0.61 | 92 |

As indicated in Table 1, the capacity retention rate varied depending on a physical property (the half-width HW) of the test electrode 61.

Specifically, when the series of materials was added at different times in the process of preparing the positive electrode mixture slurry (Examples 1 to 4 and Comparative examples 1 to 4), the capacity retention rate varied depending on the half-width HW. That is, when the half-width HW was greater than 0.50 (Comparative examples 1 to 4), the capacity retention rate decreased. In contrast, when the half-width HW was 0.50 or less (Examples 1 to 4), the capacity retention rate increased.

Note that when the series of materials was not added at different times in the process of preparing the positive electrode mixture slurry (Comparative example 5), the half-width HW was greater than 0.50 or less, and the capacity retention rate therefore decreased, as with when the half-width HW was greater than 0.50 even if the series of materials was added at different times in the process of preparing the positive electrode mixture slurry (Comparative examples 1 to 4).

### Example 5 and Comparative Examples 6 and 7

Secondary batteries were fabricated by a procedure similar to that in Example 1 and Comparative examples 1 and 5, except that the kind of the positive electrode active material was changed as presented in Table 2, following which the secondary batteries were each evaluated for a battery characteristic. Here, LiNi_{0.82}Co_{0.14}Al_{0.04}O₂ was used as a lithium-containing compound (an oxide) instead of LiCoO₂.

TABLE 2
Positive electrode active material: LiNi_{0.82}Co_{0.14}Al_{0.04}O₂

| | First process | | | Second process | | | Third process | | | | Capacity |
|---|---|---|---|---|---|---|---|---|---|---|---|
| | | Stirring | Stirring | | Stirring | Stirring | | Stirring | Stirring | Half- | retention |
| | | speed | time | | speed | time | | speed | time | width | rate |
| | Material | (rpm) | (min) | Material | (rpm) | (min) | Material | (rpm) | (min) | HW | (%) |
| Example 5 | CB | 3000 | 15 | PVDF | 2000 | 30 | CNT | 2000 | 15 | 0.45 | 100 |
| Comparative example 6 | CB | 2000 | 15 | PVDF | 3000 | 15 | CNT | 2000 | 30 | 0.59 | 93 |
| Comparative example 7 | CB + CNT + PVDF | 3000 | 60 | — | — | — | — | — | — | 0.61 | 92 |

As indicated in Table 2, when the kind of the positive electrode active material was changed also, results similar to the results presented in Table 1 were obtained. That is, when the half-width HW was greater than 0.50 (Comparative examples 6 and 7), the capacity retention rate decreased. In contrast, when the half-width HW was 0.50 or less (Example 5), the capacity retention rate increased.

### Example 6 and Comparative Example 8

Secondary batteries were fabricated by a procedure similar to that in Example 1 and Comparative example 5, except that the kind of the positive electrode conductor was changed as presented in Table 3, following which the secondary batteries were each evaluated for a battery characteristic. Here, instead of the two kinds of positive electrode conductors (carbon black (CB) and carbon nanotubes (CNT)), one kind of positive electrode conductor (carbon black) was used.

To prepare the positive electrode mixture slurry, two processes (a first process and a second process) were used as presented in Table 3. A “Material” column in Table 3 indicates the kind of the material (the positive electrode conductor or the positive electrode binder) added in each of the processes. Stirring conditions, i.e., the stirring speed (rpm) and the stirring time (min) were as presented in Table 3.

TABLE 3
Positive electrode active material: LiCoO₂

| | First process | | | Second process | | | | Capacity |
|---|---|---|---|---|---|---|---|---|
| | | Stirring | Stirring | | Stirring | Stirring | Half- | retention |
| | | speed | time | | speed | time | width | rate |
| | Material | (rpm) | (min) | Material | (rpm) | (min) | HW | (%) |
| Example 6 | CB | 3000 | 15 | PVDF | 2000 | 30 | 0.50 | 100 |
| Comparative example 8 | CB + PVDF | 3000 | 45 | — | — | — | 0.55 | 96 |

As indicated in Table 3, when the kind of the positive electrode conductor was changed also, results similar to the results presented in Table 1 were obtained. That is, when the half-width HW was greater than 0.50 (Comparative example 8), the capacity retention rate decreased. In contrast, when the half-width HW was 0.50 or less (Example 6), the capacity retention rate increased.

Based upon the results presented in Tables 1 to 3, when: the positive electrode active material layer included the positive electrode active material and the positive electrode conductor; the positive electrode conductor included the carbon material; and the half-width HW of the peak P determined based on the result of analysis of the surface of the positive electrode active material layer through the Raman spectroscopy was 0.5 or less, the capacity retention rate increased. The cyclability characteristic therefore improved. Accordingly, the secondary battery achieved a superior battery characteristic.

Although the present technology has been described herein with reference to one or more embodiments including Examples, the configuration of the present technology is not limited thereto, and is therefore modifiable in a variety of ways.

For example, the description has been given of the case where the secondary battery has a battery structure of the laminated-film type or the coin type. However, the battery structure of the secondary battery is not particularly limited. The battery structure of the secondary battery may be, for example, of a cylindrical type, a prismatic type, or a button type.

Further, the description has been given of the case where the battery device has a device structure of a wound type; however, the device structure of the battery device is not particularly limited. The device structure may be, for example, of a stacked type or a zigzag folded type. In the stacked type, the positive electrode and the negative electrode are stacked on each other. In the zigzag folded type, the positive electrode and the negative electrode are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve other effects.

Note that the present technology may have any of the following configurations according to an embodiment.

<1>

A secondary battery including:
a positive electrode including a positive electrode active material layer;
a negative electrode; and
an electrolytic solution, in which
the positive electrode active material layer includes a positive electrode active material and a positive electrode conductor,
the positive electrode conductor includes a carbon material,
a half-width of a peak is 0.50 or less, the half-width of the peak being determinable by a procedure described in (1) to (3) below, based on a result of analysis of a surface of the positive electrode active material layer through Raman spectroscopy,
(1) acquire Raman mapping of a D/G ratio by analyzing the surface of the positive electrode active material layer through the Raman spectroscopy,
(2) acquire a histogram of the D/G ratio having the peak, based on the Raman mapping, and
(3) calculate the half-width of the peak, based on the histogram.
   <2>

The secondary battery according to <1>, in which the carbon material includes a particulate carbon material and a fibrous carbon material.

<3>

The secondary battery according to <1> or <2>, in which the positive electrode active material layer further includes a positive electrode binder.

<4>

The secondary battery according to any one of <1> to <3>, in which the secondary battery includes a lithium-ion secondary battery.

<5>

A positive electrode for a secondary battery, the positive electrode including:
a positive electrode active material layer, in which
the positive electrode active material layer includes a positive electrode active material and a positive electrode conductor,
the positive electrode conductor includes a carbon material,
a half-width of a peak is 0.50 or less, the half-width of the peak being determinable by a procedure described in (1) to (3) below, based on a result of analysis of a surface of the positive electrode active material layer through Raman spectroscopy,
(1) acquire Raman mapping of a D/G ratio by analyzing the surface of the positive electrode active material layer through the Raman spectroscopy,
(2) acquire a histogram of the D/G ratio having the peak, based on the Raman mapping, and
(3) calculate the half-width of the peak, based on the histogram.

### DESCRIPTION OF REFERENCE NUMERALS

21 positive electrode
21B positive electrode active material layer
22 negative electrode

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode including a positive electrode active material layer;
a negative electrode; and
an electrolytic solution, wherein
the positive electrode active material layer includes a positive electrode active material and a positive electrode conductor,
the positive electrode conductor includes a carbon material,
a half-width of a peak is 0.50 or less, the half-width of the peak being determinable by a procedure described in (1) to (3) below, based on a result of analysis of a surface of the positive electrode active material layer through Raman spectroscopy,
(1) acquire Raman mapping of a D/G ratio by analyzing the surface of the positive electrode active material layer through the Raman spectroscopy,
(2) acquire a histogram of the D/G ratio having the peak, based on the Raman mapping, and
(3) calculate the half-width of the peak, based on the histogram.

2. The secondary battery according to claim 1, wherein the carbon material includes a particulate carbon material and a fibrous carbon material.

3. The secondary battery according to claim 1, wherein the positive electrode active material layer further includes a positive electrode binder.

4. The secondary battery according to claim 1, wherein the secondary battery comprises a lithium-ion secondary battery.

5. A positive electrode for a secondary battery, the positive electrode comprising:
a positive electrode active material layer, wherein
the positive electrode active material layer includes a positive electrode active material and a positive electrode conductor,
the positive electrode conductor includes a carbon material,
a half-width of a peak is 0.50 or less, the half-width of the peak being determinable by a procedure described in (1) to (3) below, based on a result of analysis of a surface of the positive electrode active material layer through Raman spectroscopy,
(1) acquire Raman mapping of a D/G ratio by analyzing the surface of the positive electrode active material layer through the Raman spectroscopy,
(2) acquire a histogram of the D/G ratio having the peak, based on the Raman mapping, and
(3) calculate the half-width of the peak, based on the histogram.
